(19) United States
(12) Patent Application Publication
(10) Pub. No.: US 2025/0207624 A1
(43) Pub. Date: Jun. 26, 2025

(54) Mill Liner Bore Sealing Assembly

(71) Applicant: Valley Forge & Bolt Mfg. Co., Phoenix, AZ (US)

(72) Inventors: Jason S. Melville, Laveen, AZ (US); Ronald C. Clarke, Phoenix, AZ (US); Brandon M. Proebster, Surprise, AZ (US)

(73) Assignee: Valley Forge & Bolt Mfg. Co., Phoenix, AZ (US)

(21) Appl. No.: 18/991,136

(22) Filed: Dec. 20, 2024

Related U.S. Application Data
(60) Provisional application No. 63/614,283, filed on Dec. 22, 2023.

(51) Int. Cl. F16B 43/00; F16B 39/24

(52) U.S. Cl. CPC F16B 43/001; F16B 39/24

(57) ABSTRACT

A mill liner bore sealing system includes a mill liner bolt having a shank and an oblong head, a nut configured to threadably engage with the bolt, a retaining washer including a tapered inner wall, and a sealing washer including a tapered outer surface. The retaining washer is configured to slide over the mill liner bolt, and the sealing washer is configured to nest under the retaining washer with the outer surface of the sealing washer in oblique confrontation with the inner wall of the retaining washer.

### CROSS-REFERENCE TO RELATED APPLICATIONS

This application claims the benefit of U.S. Provisional Application No. 63/614,283, filed Dec. 22, 2023, which is hereby incorporated by reference in its entirety.

### FIELD

The present specification relates generally to fasteners, and more particularly to fasteners used with industrial mills.

### BACKGROUND

The mining and extraction industry use large rotating mills to grind or self-grind ore, rock, and other types of media.

In some mills, a rotating drum catches, lifts and then drops steel balls onto ore to break the ore up into small pieces and fine particles. In other mills, the rotating drum lifts a portion of the ore along one side of the drum and drops it onto another portion of the ore below, thereby impacting, breaking, and grinding the ore. This happens continuously until the ore is ground down. Mill drums are typically constructed as an enclosed cylinder, and some mills use a slurry to aid the grinding process.

The interior of a mill drum is a caustic environment. It is hot and dirty and sometimes wet, filled with large and small pieces of rock, ore, and other materials. To protect the mill, and to aid in the grinding process, a large number of mills incorporate a covering or liner on the inside surface of the mill drum. These mill liners are sacrificial: they are intentionally designed as wear surfaces to be worn down and then replaced before the mill drum itself is damaged. This helps prolong the life of the mill and shorten repair downtime.

The mill liners are secured to the mill drum with mill bolts. A mill bolt is typically a strong, rugged shank capped with an oblong head. The head is seated in the mill liner, in the interior of the mill. The shank of the bolt extends through the mill liner through the wall of the mill drum, and is then fit with a nut on the exterior of the mill drum.

Despite the use of mill liners, damage to the mill drum itself is still possible. If dust or slurry leaks past the mill liner, it can erode the mill drum. To mitigate this, in some designs, a gasket is placed between the head of the bolt and the mill liner to prevent ingress of slurry into a bolt hole which extends through both the mill liner and the mill drum. However, after prolonged exposure to heat and vibration, the gasket can fail, and slurry can still seep into that bolt hole. Operational vibration and periodic removal and replacement of the bolt can also wear the bolt hole away.

Other types of damage are possible. In embodiments that place a washer between the nut and the mill drum, some mill operators will continually tighten the nut on the bolt to attempt to improve the seal of the gasket over time. This can cause the washer to deform or dish, or it can dig the contacting corners of the nut into the washer. This often changes torque measurements on the bolt, and because operators must monitor load values on all the bolts to ensure mill safety and operation, this damage will skew those target load values. This can lead to too much or too little maintenance on the mill, neither of which is desired.

The mill liners are meant to be replaced many times before the mill drum requires replacement. For this reason, mill liners can be switched out relatively quickly and inexpensively. However, when the mill drum is damaged by leakage or other wear, its repair or replacement can take a long time and be quite expensive. Moreover, the opportunity cost of the mill being placed out of operation an unable to process ore during that downtime is extremely high. There is a need for an improved method of securing a mill bolt.

### SUMMARY

In an embodiment, a mill liner bore sealing system includes a mill liner bolt having a shank and an oblong head, a nut configured to threadably engage with the bolt, a retaining washer including a tapered inner wall, and a sealing washer including a tapered outer surface. The retaining washer is configured to slide over the mill liner bolt, and the sealing washer is configured to nest under the retaining washer with the outer surface of the sealing washer in oblique confrontation with the inner wall of the retaining washer.

In embodiments, axial movement of the retaining washer against the sealing washer imparts radial compression of the sealing washer. Axial movement of the retaining washer against the sealing washer further imparts axial deformation of the sealing washer. The retaining washer has an inner diameter, and the sealing washer has an inner diameter equal to the inner diameter of the retaining washer. The sealing washer includes a top, a bottom, an inner wall extending from the top to the bottom, a lower face between the top and bottom extending laterally transverse to the inner wall, and an alignment collar below the lower face, wherein the alignment collar has an outwardly-directed outer face which tapers radially inward from the lower face to a lower rim at the bottom of the sealing washer. The retaining washer is rigid and the sealing washer is deformable. The sealing washer includes a notch formed in the outer surface. The retaining washer includes a rib sized and shaped to closely receive the notch in the outer surface of the sealing washer.

In an embodiment, a mill liner bore sealing system includes a mill liner bolt having an oblong head at a bottom of the bolt and a shank extending along an axis from the head to a free end at a top of the bolt, a nut configured to threadably engage with the bolt, the nut having a top, an opposed bottom, and a sidewall extending therebetween, a retaining washer configured to slide over the bolt, the retaining washer including a top, an opposed bottom, and a body therebetween, wherein the body includes a crown proximate the top and a skirt proximate the bottom, an axial annular inner face in the crown and a tapered inner wall in the skirt, and a sealing washer configured to nest within the retaining washer, the sealing washer including a top, an opposed bottom, and a body therebetween, wherein the body includes a tapered outer face configured to confront the tapered inner face of the skirt of the retaining washer.

In embodiments, the nut terminates at the bottom defined by a bottom face projecting beyond a lower face, wherein the bottom face, and the retaining washer includes a top face projecting above the crown. Onn the nut, the bottom face has a first lateral dimension and the lower face has a second lateral dimension, and on the retaining washer, the top face has a third lateral dimension and the crown has a fourth lateral dimension. The first lateral dimension is smaller than the third lateral dimension, the third lateral dimension is smaller than the second lateral dimension, and the second lateral dimension is smaller than the fourth lateral dimension.

In an embodiment, a mill liner bore sealing system includes a mill liner bolt having an oblong head at an inner end of the bolt, a threaded cylindrical shank extending from the head to an outer end of the bolt, and a tapered shoulder disposed therebetween, a retaining washer fit over the shank of the bolt, wherein the retaining washer has an outer surface, an opposed underside, and an open socket formed on the underside and having a tapered inner wall bounding a hold of the socket, a sealing washer nested in the hold of the socket against the retaining washer, the sealing washer having a top and an opposed bottom, and a nut threadably engaged with the shank. The sealing washer is configured to compress radially in response to axial movement of the retaining washer, said axial movement imparted by threaded advancement of the nut over the shank.

In embodiments, the sealing washer includes a top and an opposed bottom, an upper face at the top of the sealing washer, an outer surface extending downward from the upper face on an outer side of the sealing washer, an inner wall extending downward from the upper face on an inner side of the sealing washer, a lower face extending inward from the outer surface, and an alignment collar projecting downward from the lower face to the bottom of the sealing washer. The alignment collar is disposed between the lower face and the inner wall, and the alignment collar includes a sloped outer face. The sealing washer is configured to compress radially between the inner wall of the socket of the retaining washer and the shank. The sealing washer is configured to deform axially into the socket of the retaining washer. The inner wall of the open socket is tapered in a first direction, the outer surface of the sealing washer is also tapered in the first direction, and the first direction extends radially outward from the tops of the retaining and sealing washers to the bottoms of the retaining and sealing washers. The inner wall of the socket is formed with a rib projecting into the hold of the retaining washer, and the outer surface of the sealing washer is formed with a notch sized and shaped to closely receive the rib, such that, when the sealing washer is nested in the hold of the socket of the retaining washer, relative rotational movement of the retaining washer and the sealing washer is disabled. At the notch, the outer surface includes an outer face, and adjacent the notch, the outer surface includes a sidewall. The outer face and the sidewall are each sloped in a common direction but at different pitches. The nut terminates at a bottom end defined by a bottom face projecting beyond a lower face, wherein the bottom face has a first lateral dimension and the lower face has a second lateral dimension, and the retaining washer has a top face projecting above a crown formed with a hexagonal pattern of flat recesses, wherein the top face has a third lateral dimension and the hexagonal pattern has a fourth lateral dimension. The first lateral dimension is smaller than the third lateral dimension, the third lateral dimension is smaller than the second lateral dimension, and the second lateral dimension is smaller than the fourth lateral dimension. When the nut, retaining washer, and sealing washer are assembled on the bolt in a neutral state on a mill liner, a gap exists between the top of the sealing washer and the socket inside the hold. And when the nut, retaining washer, and sealing washer are assembled on the bolt in a torqued state on the mill liner, the gap reduces between the top of the sealing washer and the socket inside the hold.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1 is a partial perspective view of the inside of a mill, showing a mill drum, mill liners, and several mill liner bore sealing assemblies securing the mill liners to the mill drum;

FIGS. 2 and 3 are top and bottom perspective views, respectively, of one of the mill liner bore sealing assemblies of FIG. 1;

FIGS. 4 and 5 are top and bottom exploded views, respectively, of the mill liner bore sealing assembly;

FIGS. 6A and 6B are section views of a retaining washer of the mill liner bore sealing assembly, taken along the line A-A in FIG. 2;

FIGS. 7A and 7B are top and bottom perspective views of a sealing washer of the mill liner bore sealing assembly;

FIG. 8A is a section view of the mill liner bore sealing assembly, taken along the line A-A in FIG. 2;

FIG. 8B is a section view of the mill liner bore sealing assembly, taken along the line B-B in FIG. 2;

FIG. 9 is a section view of the mill liner bolt with the mill liner bore sealing assembly, taken along the line A-A; and

FIGS. 10 and 11 are enlarged section views of the mill liner bore sealing assembly, taken along the line A-A, showing the assembly in a neutral arrangement and a torqued arrangement.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

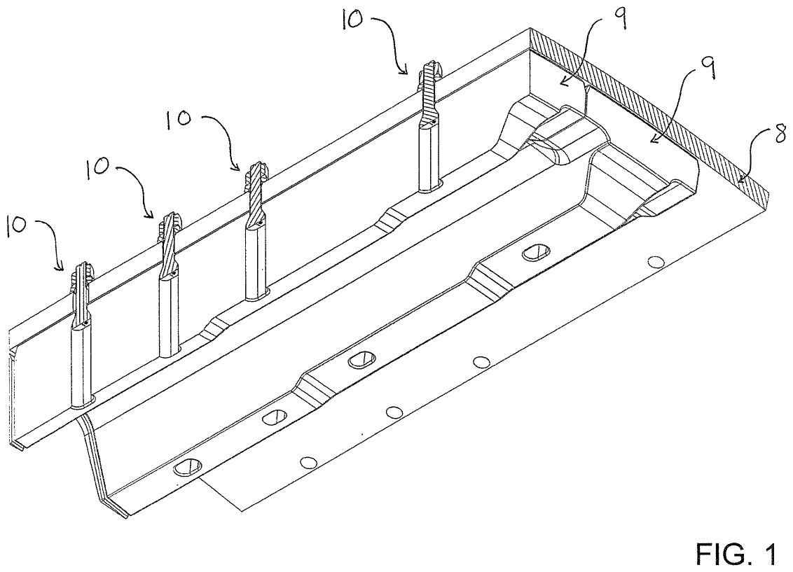

FIG. 1 is a partial perspective view of the inside of a mill, showing a mill drum 8, mill liners 9 secured to the inside of the mill drum 8, and several mill liner bore sealing systems or assemblies 10 which secure the mill liners 9 to the mill drum 8.

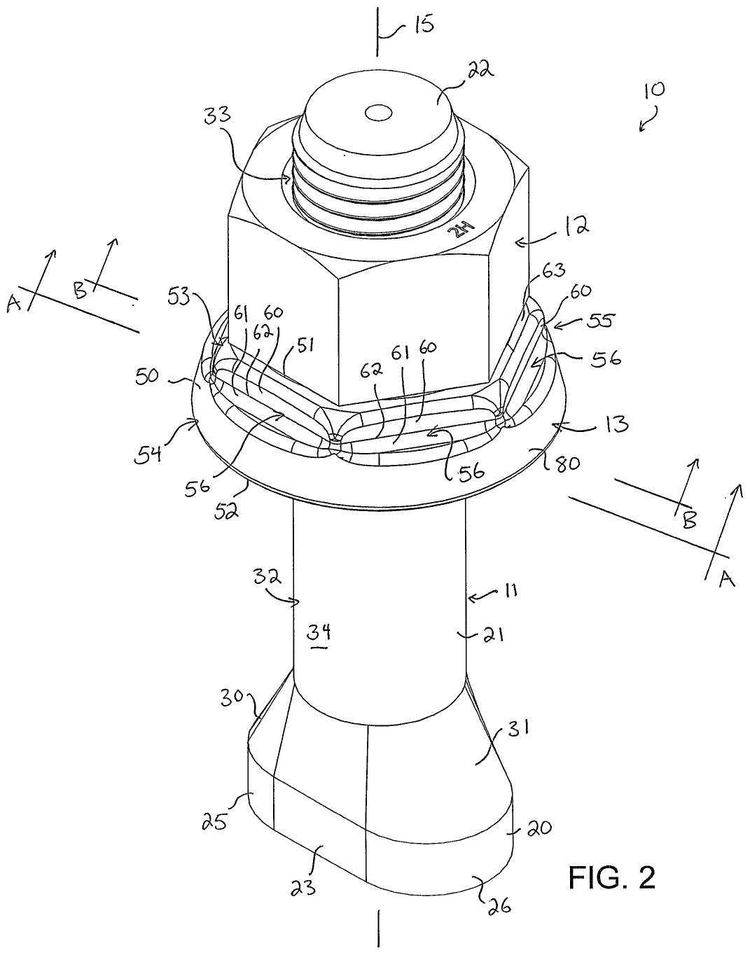

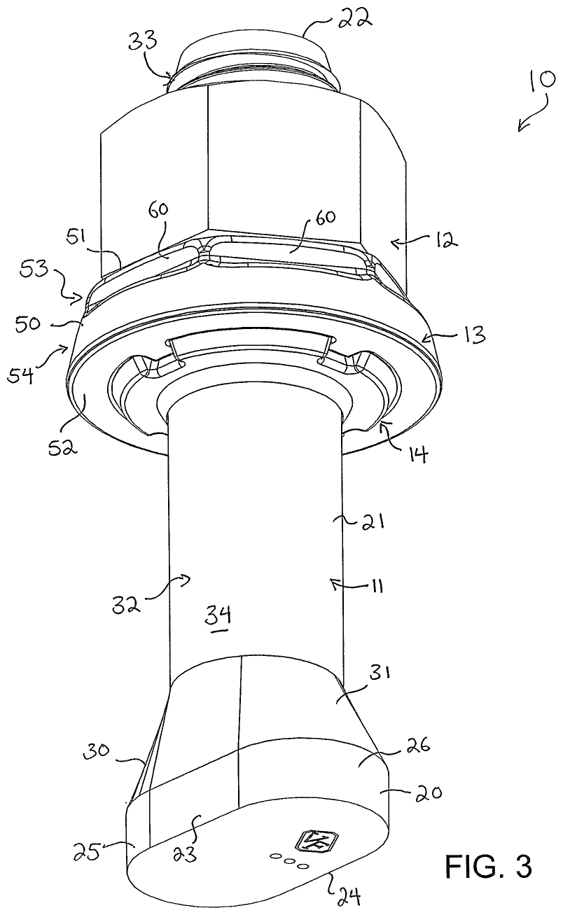

FIGS. 2 and 3 show in top and bottom perspective views, respectively one of those mill liner bore sealing assemblies 10 (hereinafter, “assembly 10”) in isolation. The assembly 10 includes a mill bolt 11, a nut 12, a retaining washer 13, and a sealing washer 14. The retaining washer 13 and sealing washer 14 define an adaptive sealing system for the mill bolt assembly.

The bolt 11 includes an oblong head 20 and a shank 21 extending integrally from the head 20 along an axis 15 and terminating at an outer or free end 22. It is briefly noted here that the free end 22 is an “outer” end because it is directed radially outward when the bolt 11 is installed in the mill. Consequently, the head 20 is an “inner” end because it is directed radially inward in the mill. Similarly, this description may refer to directions such as up, above, down, and/or below. Moreover, because the nut 12, retaining washer 13, and sealing washer 14 are preferably coaxially assembled onto the mill bolt 11 which has the axis 15, those elements share the axis 15, and description herein that is made to an axis or “axial” refer to this axis 15. Such descriptions are not made to limit the scope of the disclosure but rather to assist the reader in understanding absolute and relative positions of structural elements and features shown as in the drawings.

The bolt 11 is preferably a single, monolithic piece, constructed from a material or combination of materials having incredibly strong, rugged, and durable material characteristics, such as iron or other material which resists deformation when loaded. The head 20 is formed integrally and monolithically at and to the inner end of the shank 21. The head 20 is enlarged and oblong with respect to the shank 21, having two parallel flat faces 23 and 24 which are coextensive and spaced apart from each other by approximately the diameter of the shank 21. The faces 23 and 24 extend between opposed lobes 25 and 26 of the head 20. Those lobes 25 and 26 are semicylindrical and project convexly outwardly from a center of the head 20, beyond the diameter of the shank 21. The lobes 25 and 26 are spaced apart by the faces 23 and 24 and a body portion of the head 20 that is between the faces 23 and 24. The head 20 further includes two semi-conical, truncated, tapered shoulders or surfaces 30 and 31 extending from the lobes 25 and 26 to the shank 21.

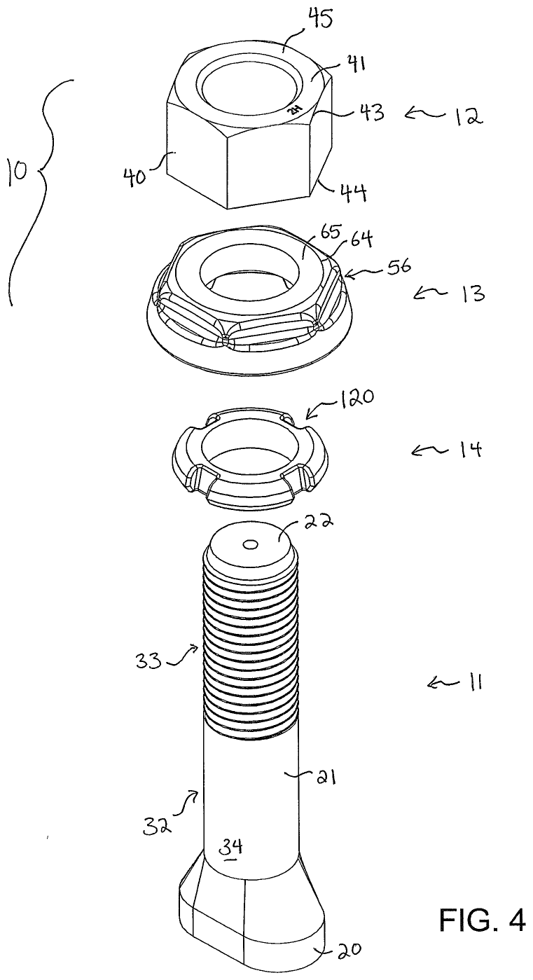

Referring still to FIGS. 2 and 3 but also to FIG. 4, the shank 21 is formed integrally and monolithically to the head 20 and extends distally therefrom. The shank 21 terminates at the free end 22. The shank 21 is cylindrical and includes a grip or unthreaded portion 32 proximate the head 20 and a threaded portion 33 proximate the free end 22. Along the unthreaded portion 32, an outer surface 34 of the shank 21 is smooth, and along the threaded portion 33, the outer surface 34 includes outwardly-directed threads having an outer or major diameter and a pitch. The free end 22 of the shank 21 is preferably flat and normal to the length of the shank 21.

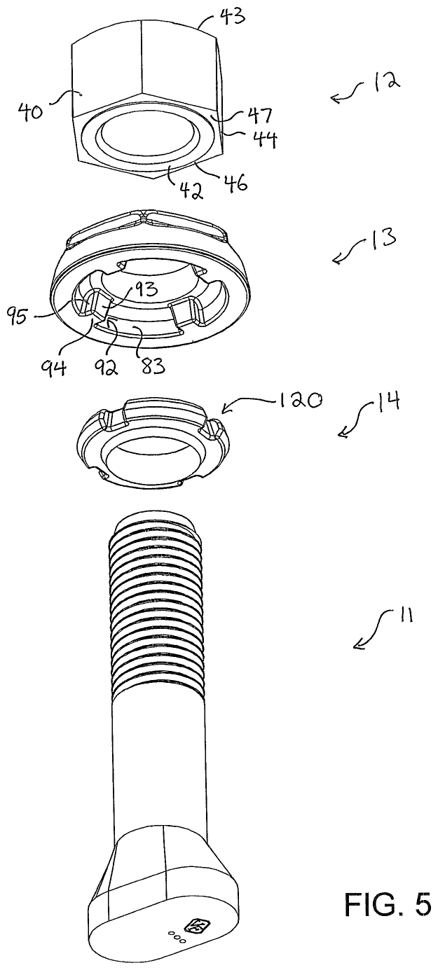

The nut 12 is designed to threadably engage with the bolt 11. Referring primarily to FIGS. 4 and 5 now, the nut 12 has a generally hexagonal prismatic configuration, with a hexagonal sidewall 40 extending between opposed top and bottom ends 45 and 46 of the nut 12. The nut 12 is preferably a single, monolithic piece, constructed from a material or combination of materials having incredibly strong, rugged, and durable material characteristics, such as iron or other material which resists deformation when loaded.

At the top end 45 of the nut 12 is an outer or top face 41. The top face 41 is annular and projects just slightly beyond the upper edge 43 of the sidewall 40. The nut has a thin upper face that extends inward from the upper edge 43 to the projection forming top face 41.

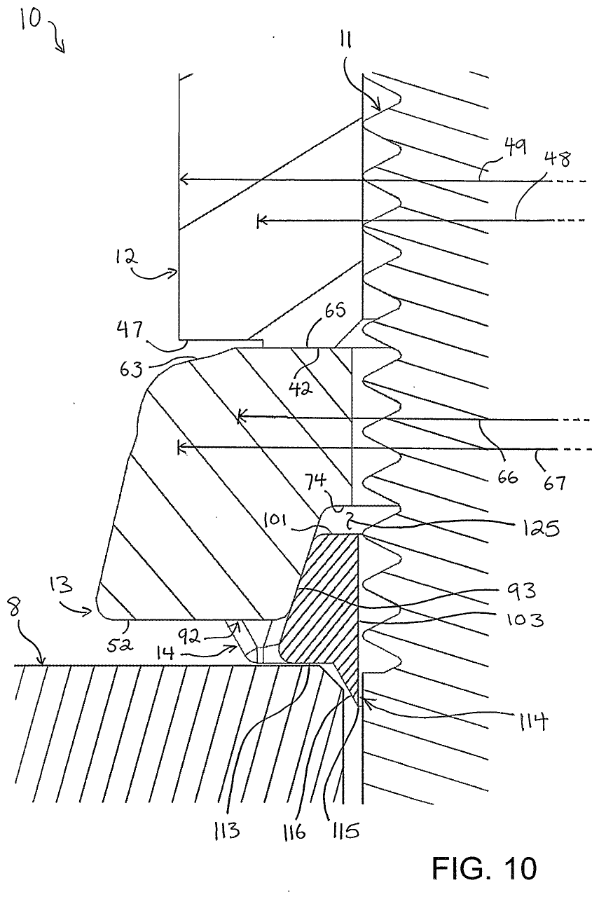

Opposite the top face 41 is an inner or bottom face 42. The bottom face 42 is annular and projects just slightly beyond a lower face 47 of the sidewall 40. The lower face 47 is a flat face having a hexagonal outer edge defining a lower edge 44 of the sidewall 40 of the nut 12. The lower face 47 extends radially inward to a downward projection, forming a shoulder with the downward projection. Again, although reference is made herein to directions like “upper,” “lower,” “top,” and “bottom,” the reader will understand that these terms are used only for ease when referring to the drawings that show a vertical orientation. In operation and use, the nut 12 may have other configurations or orientations, especially given that the mill in which the nut is used is constantly rotating during operation. The inner or bottom face 42 of the nut 12 is simply the face which is directed radially inward (with respect to the mill) and thus is directed toward the retaining washer 13. The bottom face 42 therefore defines a contacting face 42. The bottom face 42 projects down beyond the lower face 47 to the bottom end 46 of the nut 12 where the nut 12 terminates. Referring briefly to FIG. 10, the bottom face 42 has a lateral or outer diameter 48 and the lower face 47 has a lateral or outer diameter 49 which is greater than the outer diameter 48.

With reference back to FIGS. 2 and 3, the nut 12 is shown threadably engaged to the threaded portion 33 of the shank 21. Just below the nut 12, and in contact and confronting relation with the nut 12, is the retaining washer 13. The retaining washer 13 has a body 50 which is preferably a single, monolithic piece, constructed from a material or combination of materials having incredibly strong, rigid, rugged, and durable material characteristics, such as iron or other material which resists deformation when loaded. The body 50 is roughly annular, has a top 51 and an opposed bottom 52, and generally has two portions: an upper portion 53 and an opposed lower portion 54.

The upper portion 53 has a crown 55 with a hexagonal pattern of flat recesses 56 disposed circumferentially around the crown 55, each recess 56 spaced slightly apart from adjacent recesses 56. Each of the recesses 56 defines a flat, vertical face 60 and a coextensive, flat, horizontal face 61 meeting along an internal right corner 62. The pattern of recesses 56 on the crown 55 allows an operator to fit a hex wrench or impact driver over the retaining washer 13 to engage with it and loosen it.

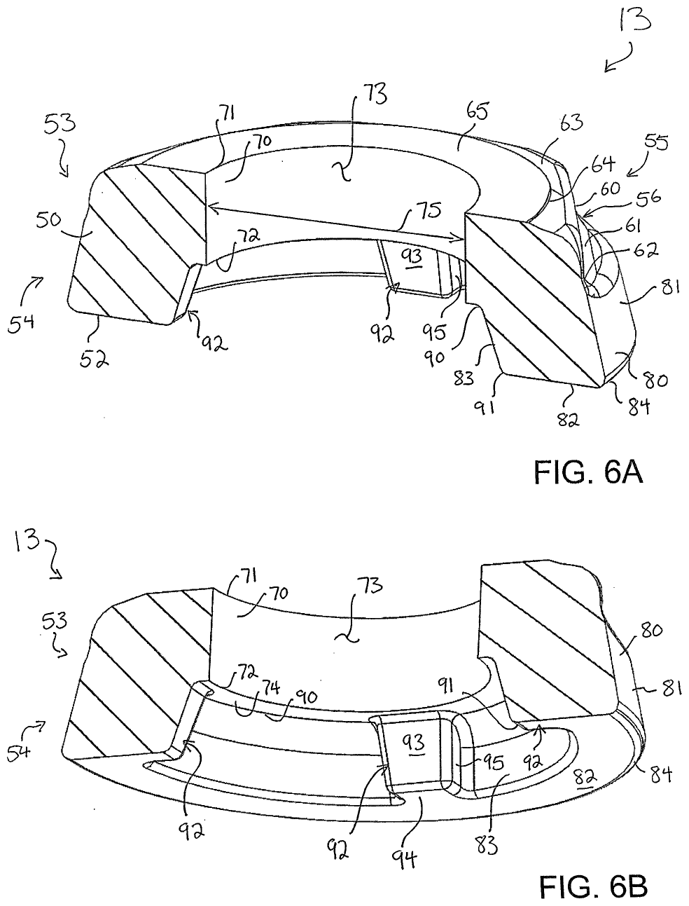

Referring now to FIG. 4 and also to FIGS. 6A and 6B, just above the pattern of recesses 56, the crown 55 turns radially inward to define a slightly canted crown top 63 which is annular. Inboard of the recesses 56, a short annular projection 64 extends upwardly from the crown top 63 and terminates at a top contact face 65. The contact face 65 is annular, smooth, flat, and normal to the axis 15 oriented coaxially with respect to the retaining washer 13. With brief reference to FIG. 10, the top contact face 65 has a lateral or outer diameter 66 and the crown 63 has a lateral or outer diameter 67 which is greater than the outer diameter 66. The outer diameter 48 of the bottom face 42 is smaller than the outer diameter 66 of the top contact face 65. The outer diameter 66 of the top contact face 65 is smaller than the outer diameter 49 of the lower face 47. The outer diameter 49 of the lower face 47 is smaller than the outer diameter 67 of the crown 63.

As shown in FIGS. 6A and 6B, which are section views through the retaining washer 13 taken along the line B-B in FIG. 2, the upper portion 53 further includes a vertical inner wall 70. The inner wall 70 extends downward from an inner upper edge 71 of the contact face 65 (with which the inner wall 70 defines an inner, upper corner of the retaining washer 13) to an opposed, inner lower edge 72. This inner wall 70 is annular and defines a central bore 73 through the retaining washer 13. The bore 73 has an inner diameter 75, defined by the inner diameter of the inner wall 70, which corresponds to the major diameter of the threaded portion 33 of the bolt 11. The bore 73 also bounds and defines a hold configured to receive the sealing washer 14 in nesting arrangement therein.

The upper portion 53 overhangs the lower portion 54 at the inner lower edge 72. As shown best in FIG. 6B, the upper portion 54 has an overhanging lower surface 74. This lower surface 74 is annular and extends radially outwardly away from the inner lower edge 72 to the lower portion 54. The lower surface 74 is below each of the horizontal faces 61 of the recesses 56. It extends laterally transverse to the inner wall 103 and radially inward from a bottom of the outer surface 117.

The lower portion 54 includes a skirt 80 which depends from the upper portion 53. The skirt 80 is annular and continuous, extending entirely around the retaining washer 13. The skirt 80 includes an outer sidewall 81, a bottom face 82, and an inner sidewall 83. Each of the sidewall 81, bottom face 82, and sidewall 83 is smooth.

The outer sidewall 81 is tapered. At its top, where the outer sidewall 81 meets the pattern of recesses 56, the outer sidewall 81 has a first diameter. The outer sidewall 81 extends downward and radially outward therefrom, terminating at a lower peripheral edge 84, where the sidewall 81 has a second diameter. The second diameter of the sidewall 81 is larger than its first diameter. The sidewall 81 therefore defines the lower portion 54 as a tapered frustoconical body.

The bottom face 82 is annular, smooth, flat, and normal to the axis 15 oriented coaxially with respect to the retaining washer 13.

The inner sidewall 83 also has a frustoconical shape. The inner sidewall 83 has an upper edge 90 which forms an inner corner with the lower surface 74 of the upper portion 54. At the upper edge 90, the inner sidewall 83 has a first diameter. The inner sidewall 83 extends downward and radially outward therefrom, terminating at a lower edge 91, where the inner sidewall 83 has a second diameter. The second diameter of the inner sidewall 83 is larger than its first diameter. The inner sidewall 83 therefore defines the lower portion 54 with a tapered frustoconical inner profile. Preferably, the inner sidewall 83 and the outer sidewall 81 are nearly, but not necessarily, parallel each other.

A set of preferably four ribs 92 interrupts the inner sidewall 83. Referring still to FIGS. 6A and 6B but also to FIG. 5, these ribs 92 are formed integrally and monolithically as part of the inner sidewall 83, but they project radially inward therefrom into the hold or bore 73 of the retaining washer 13. The ribs 92 are identical in every respect but location, and so only one is described below with the understanding that the description applies equally to all. The ribs 92 are spaced apart from each other approximately at intervals of one-quarter of the inner sidewall 83. Each rib 92 has a body defining an inner face 93, a lower face 94, and opposed side faces 95. The ribs 92 increase the rigidity of the retaining washer 13, preventing it from flexing, compressing, dishing, or otherwise deforming.

The lower face 94 is coplanar to the bottom face 82 of the skirt 80 and as such defines a planar extension radially inward from the skirt 80. This extension enlarges the surface available for contact beyond that of the bottom face 82.

The inner face 93 is angled and roughly parallel to the inner sidewall 81 proximate the respective rib 92. It extends down the lower surface 74 of the upper portion 54, inboard approximately one-third of the distance between the inner lower edge 72 of the inner wall 70 and the upper edge 90 of the inner sidewall 83, terminating at a lower corner with the lower face 94.

The opposed sides 95 of the rib 92 extend from the inner sidewall 83 of the skirt 80 radially inward to the inner face 93, and from the lower surface 74 of the upper portion 53 down to the lower face 94 of the lower portion 54. The sides 95 are planar and oriented roughly radially with respect to the body 50 of the retaining washer 13.

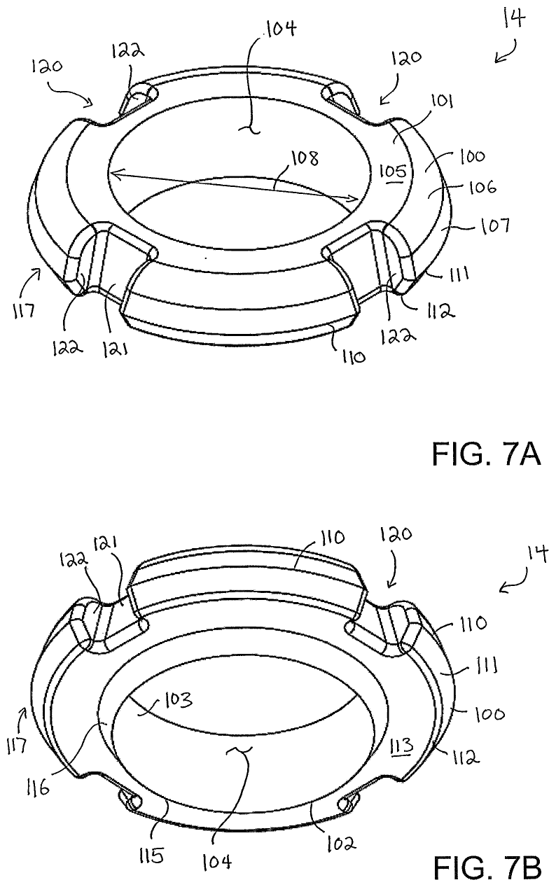

The sealing washer 14 fits into the retaining washer 13 in a nesting arrangement. Referring primarily to FIGS. 7A and 7B, the sealing washer 14 is shown in isolated detail in top and bottom perspective views, respectively. The sealing washer 14 has a body 100 which preferably is a single, monolithic piece, constructed from a material or combination of materials having rugged, deformable, durable, and resilient material characteristics, such as rubber. The body 100 is roughly annular and has a top 101 and an opposed bottom 102.

The sealing washer 14 includes a vertical inner wall 103. The inner wall 103 extends entirely between the top 101 and the bottom 102. The inner wall 103 is annular and defines a central bore 104 through the sealing washer 14. The bore 104 has an inner diameter 108, defined by the inner diameter of the inner wall 103, which corresponds to the major diameter of the threaded portion 33 of the bolt 11. The bore 104 has the same shape and size as the bore 73 of the retaining washer 13. The inner diameter 108 of the sealing washer 14 is equal to the inner diameter 75 of the retaining washer 13.

The sealing washer 14 has an upper face 105 at its top 101. The upper face 105 is annular, smooth, flat, and normal to an axis oriented coaxially with respect to the sealing washer 14. The upper face 105 extends radially outward from the inner wall 103. Distal from the inner wall 103, the sealing washer 14 has a fillet 106 which arcuately transitions radially outward to a tapered sidewall 107 below. Both the fillet 106 and the sidewall 107 are annular.

The sidewall 107 tapers outwardly at an angle. It has a first diameter at the fillet 106. From there, the sidewall 107 extends downward and radially outward slightly, terminating at an outer edge 110. At the outer edge 110, the sidewall 107 has a second diameter. The second diameter of the sidewall 107 is greater than its first diameter. The sidewall 107 therefore defines a frustoconical shape for at least part of the sealing washer 14.

From the outer edge 110, another sidewall 111 tapers inwardly. The sidewall 111 is an extension of the sidewall 107. At the outer edge 110, the sidewall 111 has a first diameter. The sidewall 111 then extends downward and radially inward, terminating at a second fillet 112. At the second filler 112, the sidewall 111 has a second diameter which is less than the first diameter of the sidewall 111. The sidewall 111 therefore gives the sealing washer 14, on a lower portion of the body 100, a frustoconical shape which is roughly inverted with respect to the shape above the outer edge 110.

The fillet 112 arcuately transitions from the tapered sidewall 111 to a flat lower face 113. The lower face 113 is annular, smooth, flat, and normal to an axis oriented coaxially with respect to the sealing washer 14. The lower face 113 extends inward to an alignment collar 114.

The alignment collar 114 is an annular structure having a sloped, annular outer face 116 extending from the lower face 113 and terminating at a rim 115. The rim 115 is formed by the juncture of the outer face 116 and the inner wall 103 which extends through the sealing washer 14. Preferably, the angle of the outer face 116 is nearly, but not necessarily, parallel to the sidewall 111. In some embodiments, the alignment collar 114 is more prominent, meaning it extends further from the lower face 113 than is shown in these drawings. In other embodiments, the alignment collar 114 is less prominent than is shown in these drawings. Moreover, in some embodiments, the angle of the outer face 116 is different from that shown in these drawings.

The upper face 105, the fillet 106, the sidewall 107, the outer edge 110, the sidewall 111, the fillet 112, the lower face 113 of the sealing washer 14 all define an outer surface 117 of the sealing washer 14.

The sealing washer 14 includes several notches 120 interrupting the otherwise annular body 50. The notches 120 are recesses extending vertically through the body 50, set in from the outer surface 117 of the sidewall 107. They form open sockets in the outer surface 117, and they are sized and shaped to closely receive the ribs 92 of the retaining washer 13.

Each notch 120 includes an outer face 121 and opposed side faces 122. The outer face 121 has the shape of an isosceles trapezoid; its top is wider than its bottom. Proximate the top 101 and the upper face 105, the outer face 121 has a first dimension extending between the two opposed side faces 122. Proximate the bottom 102 and the lower face 113, the outer face 121 has a second dimension extending between the two opposed side faces 122. The first dimension of the outer face 121 is greater than the second dimension. As such, the outer face 121 narrows from top to bottom.

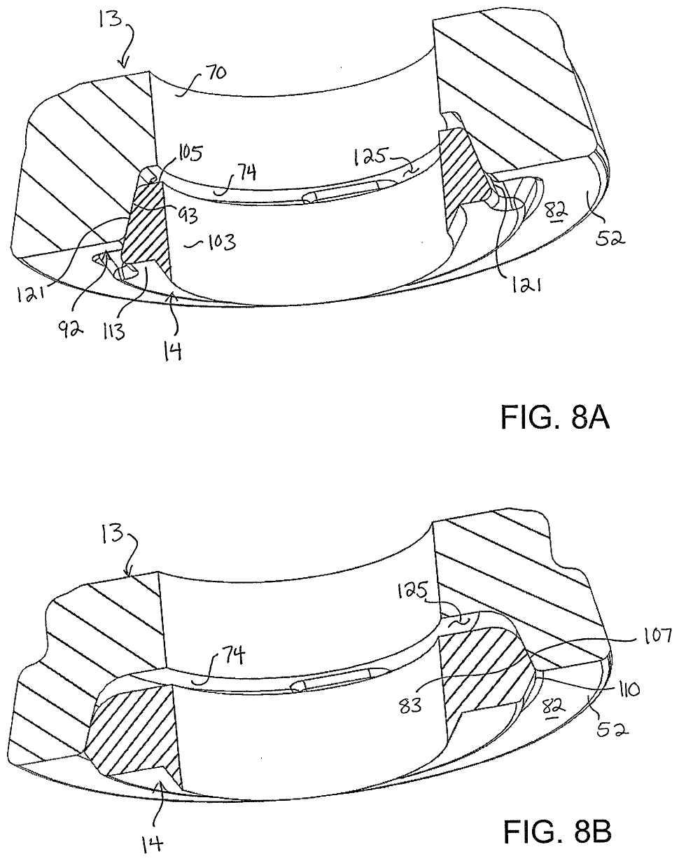

The outer face 121 is angled outward, as best shown in the section view of FIG. 8A which is taken along the line A-A in FIG. 2. That line A-A bisects the retaining washer 13 and the sealing washer 14 nested together, and extends through two ribs 92 in the retaining washer 13 and two notches 120 in the sealing washer 14. The outer face 121 is closer to the inner wall 103 proximate the upper face 105 than proximate the lower face 113. AS the outer face 121 extends down from the upper face 105, it also extends radially outward. As can be seen in FIG. 8A, the slope of the outer face 121 corresponds to the slope of the inner face 93 of the rib 92. The angle of the outer face 121 is different from the angle of the sidewall 107, though they are sloped in the same common direction.

FIGS. 8A and 8B show the sealing washer 14 nested under the retaining washer 13. To so nest these parts, the operator aligns the retaining washer 13 above the sealing washer 14, with the bottom 52 of the retaining washer 13 directed at the top 101 of the sealing washer 14. The operator then registers the inner wall 70 of the retaining washer 13 with the inner wall 103 of the sealing washer 14. Finally, the operator rotates one of the retaining or sealing washers 13, 14 until the ribs 92 are registered with the notches 120. The retaining washer 13 and sealing washer 13 are then moved together, so that much of the outer surface 117 of the sealing washer 13 moves into the bore 73 of the retaining washer 13.

The notches 120 closely receive the ribs 92. The ribs 92 are also tapered, such that they narrow in size from their tops to their bottoms. As such, when the retaining washer 13 is first moved over the sealing washer 14, the wider end of each notch 120 receives the narrower end of each rib 92. As the washers 13 and 14 are further moved together, the ribs 92 are guided by interaction and abutment with the opposed side faces 122 of the notch 120 to ensure that each rib 92 is centered in each notch 120. This helps ensure that the two washers 13 and 14 nest in a coaxial arrangement with each other.

Further helping ensure this coaxial arrangement is the relative sloped faces of the washers 13 and 14. As the rib 92 slides into the notch 120, the sloped inner face 93 of the rib 92 meets the sloped outer face 121 of the notch and slides against it. This causes the sealing washer 14 to center within the retaining washer 13, thereby ensuring coaxial alignment.

Moreover, as shown in FIG. 8B, other structures help to ensure the coaxial alignment. FIG. 8B is a section view of the retaining washer 13 and the sealing washer 14 nested together, taken along the line B-B in FIG. 2, which line does not pass through two ribs 92 in the retaining washer 13 and the two notches 120 in the sealing washer 14. The view of FIG. 8B is parallel to but offset from the view of FIG. 8A.

Not only do the rib 92 and notch 120 contact, slide along, and guide each other, but so do the inner sidewall 83 of the retaining washer 13 and the sidewall 107 of the sealing washer 14. As the retaining washer 13 and the sealing washer 14 nest together, the inner sidewall 83, which is sloped, meets and slides along and against the similarly-sloped sidewall 107 in oblique confrontation. This also causes the sealing washer 14 to center within the retaining washer 13, thereby ensuring coaxial alignment. When nested, the outer edge 110 of the sealing washer 14 is roughly coplanar to the bottom face 82 of the retaining washer 13.

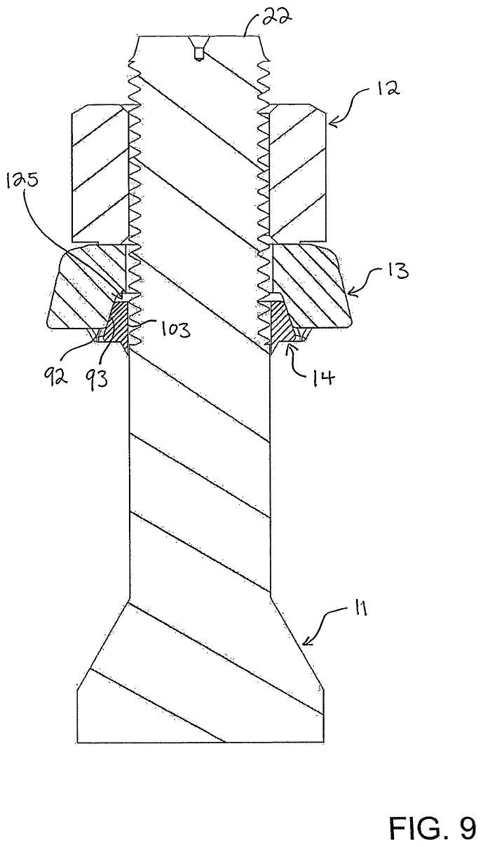

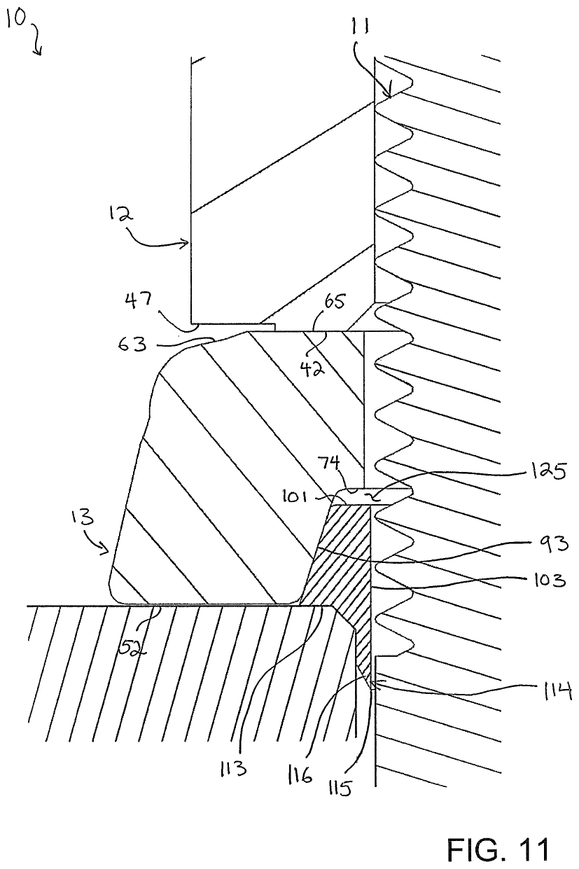

As can be seen in FIGS. 8A and 8B, which show a nested arrangement of the retaining washer 13 and the sealing washer 14, there is a shallow gap 125 between the two washers 13 and 14. When the two washers 13 and 14 are in a neutral arrangement and not under any significant torque, as shown in FIGS. 8A and 8B, this gap 124 is preferably maintained. Further advancement or application of relative axial movement between the retaining washer and the sealing washer 14, as shown below, causes the sealing washer 14 to be radially compressed; the sloped faces of the two washers 13 and 14 forces the body 100 of the sealing washer 14 radially inward. However, as shown in FIGS. 9 and 10, when the retaining washer 13 and the sealing washer 14 are fit over the bolt 11, the outer diameter of the shank 21 limits the amount that the sealing washer 14 can be radially displaced inward. Since the inner diameter of the inner wall 103 corresponds to the diameter of the outer diameter of the shank 21, the sealing washer 14 cannot radially displace much. Thus, the sealing washer 14 becomes radially compressed and wedged between the inner sidewall 83 of the retaining washer 13 and the inner face 93 of the rib 9. Because the sealing washer 14 can only compress radially to a limited amount, continued axial movement of the two washers 13 and 14 with respect to each other also imparts axial deformation within the hold 73, such that the sealing washer 14 moves slightly into the gap 125. In other words, when the nut 12, retaining washer 13, and sealing washer 14 are in a torqued arrangement, and the bolt 11 is applied to a mill liner 9 and mill drum 8, the sealing washer 14 moves into and reduces the vertical or axial dimension of the gap 125 between the top of the sealing washer and the lower surface 74 in the hold 73. This torqued arrangement is shown in FIG. 11.

In operation, a mill liner 9 is held inside the mill drum 8, against the inner surface of the mill drum 8 or against an intermediate surface on the mill drum 8, and one of the bolts 11 is passed through a bolt hole formed in the mill liner 9. The bolt 11 is further passed through a registered bolt hole in the mill drum 8 until the free end 22 of the bolt 11 emerges on the exterior of the mill drum 9.

The operator takes the sealing washer 14, moves it over the free end 22 of the bolt 11, and registers the bore 104 in the sealing washer 14 with the shank 21 of the bolt 11. The operator then moves the sealing washer 14 down onto the shank 21, with the rim 115 of the sealing washer 14 directed toward the mill drum. The shank 21 of the bolt 11 moves into the bore 104 of the sealing washer 14, and the operator continues moving the sealing washer 14 down the shank 21 until the sealing washer 14 is seated against the mill drum 9. The alignment collar 114 fits into the mill drum's bolt hole, which is often countersunk (as it is in FIG. 11). The alignment collar 114 helps center the sealing washer 14 in the bolt hole and with respect to the shank 21. The sealing washer 14 is seated when its lower face 113 is in contact against the exterior surface of the mill drum 9.

Next, the operator takes the retaining washer 13, moves it over the free end 22 of the bolt 11, and registers its bore 73 with the shank 21. The operator then slides the retaining washer 13 down onto the shank 21, with bottom 52 of the retaining washer 13 directed toward the mill drum 9. The shank 21 of the bolt 11 moves into the bore 73 of the retaining washer 13, and the operator continues moving the retaining washer 13 down the shank 21 until the retaining washer 13 receives the sealing washer 13 in its bore 73. Application of some force causes the retaining washer 13 and the sealing washer 14 to nest as described above.

Next, the operator takes up the nut 12 and threadably engages it with the bolt 11. The operator may be able to freely spin the nut 12 down the threaded portion 33 or may need a tool, such as a socket wrench or impact wrench. The operator spins the nut 12 on the bolt 11 until the bottom face 42 of the nut 12 is in or near contact with the contact face 65 on top of the retaining washer 13. This places the assembly 10 into the neutral arrangement shown in FIG. 10.

The operator then uses an impact wrench to apply high torque to the nut 12. Because the contact face 65 projects slightly above the crown top 63 of the retaining washer 13, if the lower edge 44 of the sidewall 40 of the nut 12, or some other part of the nut 12, digs into the retaining washer 13, it will only damage the contact face 65 rather than the hexagonal pattern of recesses 56, thereby mitigating any damage to the interface for a tool on the retaining washer 13. Moreover, the retaining washer 13 does not flex or dish, because the ribs 92 provide rigidity to the retaining washer 13. Without flexing, the operator can read true torque levels.

As the operator tightens the nut 12, he applies torque, which creates an axial compressive force from the nut 12 to the retaining washer 13, which is then transferred to the sealing washer 14 nested within the retaining washer 13. The sloped conical interface of the retaining washer 13 and the sealing washer 14 transfers this axial force into a radial force, thereby causing a reduction in the inner diameter of the sealing washer 14. The sealing washer 14 deforms. It tightens or “snugs up” against the shank 21, ensuring a high-quality seal between the shank 21 and the sealing washer 14. Further, the axial force causes the alignment collar 114 to squeeze into the countersunk bolt hole and causes the lower face 113 of the sealing washer 14 to seal against the exterior of the mill drum 9. Therefore, there is a seal from the mill drum exterior to the sealing washer 14 to the shank 21 preventing the transmission or leakage of slurry out of the bolt hole in the mill drum. The radial compression also causes the top 101 of the sealing washer 14 to deform axially upward and reduce the gap 125. This places the assembly 10 into the torqued arrangement shown in FIG. 11. All mill bolts are subsequently secured to the mill drum this way.

Over time, the bolt holes may elongate and erode. However, because the force on the retaining washer 13 causes the sealing washer 14 to deform, the seal between the mill drum, sealing washer 14, and shank 21 is maintained.

When the mill liner is worn down and needs to replaced, the operator will use a socket wrench, impact wrench, or even a torch to back the nut 12 off of the shank 21. To remove the retaining washer 13, the operator uses a tool with a hexagonal socket or hexagonal jaws. The operator fits that hex tool over the pattern of recesses 56 on the crown 55 of the retaining washer 13 and turns the retaining washer 13. The retaining washer 13 rotates on the shank 21. Moreover, because the sealing washer 14 is engaged with the retaining washer 13 at the interface between the ribs 92 and the notches 120, relative rotational movement of the retaining and sealing washers 13 and 14 is disabled, and so the sealing washer 14 also rotates on the shank 21. The operator need only rotate the washers 13 and 14 so much that the washers 13 and 14 break free from the mill drum. The operator can then simply slide the washers off the shank 21. The operator then installs a new mill liner, bolt 11, retaining washer 13, sealing washer 14, and nut 12. After replacing all of the worn mill liners, the mill drum is again ready for operation.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A mill liner bore sealing system comprising:
a mill liner bolt having a shank and an oblong head;
a nut configured to threadably engage with the bolt;
a retaining washer including a tapered inner sidewall, the retaining washer configured to slide over the mill liner bolt; and
a sealing washer including a tapered sidewall;
wherein the sealing washer is configured to nest under the retaining washer with the sidewall of the sealing washer in oblique confrontation with the inner sidewall of the retaining washer.

2. The mill liner bore sealing system of claim 1, wherein axial movement of the retaining washer against the sealing washer imparts radial compression of the sealing washer.

3. The mill liner bore sealing system of claim 1, wherein axial movement of the retaining washer against the sealing washer further imparts axial deformation of the sealing washer.

4. The mill liner bore sealing system of claim 1, wherein the retaining washer has an inner diameter, and the sealing washer has an inner diameter equal to the inner diameter of the retaining washer.

5. The mill liner bore sealing system of claim 1, wherein the sealing washer comprises:
a top, a bottom, and an outer surface extending from the top to the bottom;
an inner sidewall extending from the top to the bottom;
a lower face between the top and bottom extending laterally transverse to the inner sidewall and radially inward from a bottom of the outer surface; and
an alignment collar below the lower face, wherein the alignment collar has an outwardly-directed outer face which tapers radially inward from the lower face to a lower rim at the bottom of the sealing washer.

6. The mill liner bore sealing system of claim 1, wherein the retaining washer is rigid and the sealing washer is deformable.

7. The mill liner bore sealing system of claim 1, wherein the sealing washer includes a notch formed in the sidewall.

8. The mill liner bore sealing system of claim 7, wherein the retaining washer includes a rib sized and shaped to closely receive the notch in the sidewall of the sealing washer.

9. A mill liner bore sealing system comprising:
a mill liner bolt having an oblong head at a bottom of the bolt and a shank extending along an axis from the head to a free end at a top of the bolt;
a nut configured to threadably engage with the bolt, the nut having a top, an opposed bottom, and a sidewall extending therebetween;
a retaining washer configured to slide over the bolt, the retaining washer including a top, an opposed bottom, and a body therebetween, wherein the body includes a crown proximate the top and a skirt proximate the bottom, an axial annular inner face in the crown and a tapered inner sidewall in the skirt; and
a sealing washer configured to nest within the retaining washer, the sealing washer including a top, an opposed bottom, and a body therebetween, wherein the body includes a tapered sidewall configured to confront the tapered inner sidewall of the skirt of the retaining washer.

10. The mill liner bore sealing system of claim 9, wherein:
the nut terminates at the bottom defined by a bottom face projecting beyond a lower face, wherein the bottom face; and
the retaining washer includes a top face projecting above the crown.

11. The mill liner bore sealing system of claim 10, wherein:
on the nut, the bottom face has a first lateral dimension and the lower face has a second lateral dimension;
on the retaining washer, the top face has a third lateral dimension and the crown has a fourth lateral dimension;
the first lateral dimension is smaller than the third lateral dimension;
the third lateral dimension is smaller than the second lateral dimension; and
the second lateral dimension is smaller than the fourth lateral dimension.

12. A mill liner bore sealing system comprising:
a mill liner bolt having an oblong head at an inner end of the bolt, a cylindrical shank extending from the head to an outer end of the bolt, and a tapered shoulder disposed therebetween;
a retaining washer fit over the shank of the bolt, wherein the retaining washer has an outer surface and a tapered inner sidewall bounding a hold;
a sealing washer nested in the hold against the retaining washer, the sealing washer having a top and an opposed bottom; and
a nut threadably engaged with the shank;
wherein the sealing washer is configured to compress radially in response to axial movement of the retaining washer, said axial movement imparted by threaded advancement of the nut over the shank.

13. The mill liner bore sealing system of claim 12, wherein the sealing washer includes:
a top and an opposed bottom, an upper face at the top of the sealing washer, an sidewall extending downward from the upper face on an outer side of the sealing washer, an inner sidewall extending downward from the upper face on an inner side of the sealing washer, a lower face extending inward from the sidewall; and
an alignment collar projecting downward from the lower face to the bottom of the sealing washer, wherein:
the alignment collar is disposed between the lower face and the inner sidewall; and
the alignment collar includes a sloped outer face.

14. The mill liner bore sealing system of claim 12, wherein the sealing washer is configured to compress radially between the inner sidewall of the hold of the retaining washer and the shank.

15. The mill liner bore sealing system of claim 12, wherein the sealing washer is configured to deform axially into the hold of the retaining washer.

16. The mill liner bore sealing system of claim 12, wherein:
the inner sidewall of the hold is tapered in a first direction;
the sidewall of the sealing washer is also tapered in the first direction; and
the first direction extends radially outward from the tops of the retaining and sealing washers to the bottoms of the retaining and sealing washers.

17. The mill liner bore sealing system of claim 12, wherein:
the inner sidewall of the hold is formed with a rib projecting into the hold; and
the sidewall of the sealing washer is formed with a notch sized and shaped to closely receive the rib, such that, when the sealing washer is nested in the hold of the retaining washer, relative rotational movement of the retaining washer and the sealing washer is disabled.

18. The mill liner bore sealing system of claim 17, wherein:
at the notch, the sidewall includes an outer face;
adjacent the notch, the sidewall includes an outer surface; and
the outer face and the outer surface are each sloped in a common direction but at different angles.

19. The mill liner bore sealing system of claim 12, wherein:
the nut terminates at a bottom end defined by a bottom face projecting beyond a lower face, wherein the bottom face has a first lateral dimension and the lower face has a second lateral dimension;
the retaining washer has a top face projecting above a crown formed with a hexagonal pattern of flat recesses, wherein the top face has a third lateral dimension and the hexagonal pattern has a fourth lateral dimension;
the first lateral dimension is smaller than the third lateral dimension;
the third lateral dimension is smaller than the second lateral dimension; and
the second lateral dimension is smaller than the fourth lateral dimension.

20. The mill liner bore sealing system of claim 12, wherein:
when the nut, retaining washer, and sealing washer are assembled on the bolt in a neutral arrangement on a mill liner, a gap exists between the top of the sealing washer and the hold; and
when the nut, retaining washer, and sealing washer are assembled on the bolt in a torqued arrangement on the mill liner, the gap reduces between the top of the sealing washer and the hold.
